(19) United States
(12) Patent Application Publication
(10) Pub. No.: US 2023/0237400 A1
(43) Pub. Date: Jul. 27, 2023

(54) VALUE CHAIN PLANNING APPARATUS, VALUE CHAIN PLANNING SYSTEM, AND VALUE CHAIN PLANNING METHOD

(71) Applicant: HITACHI, LTD., Tokyo (JP)

(72) Inventors: Tazu NOMOTO, Tokyo (JP); Takahiro OGURA, Tokyo (JP); Teppei INOUE, Tokyo (JP)

(21) Appl. No.: 17/978,345

(22) Filed: Nov. 1, 2022

(30) Foreign Application Priority Data
Jan. 21, 2022 (JP) 2022-008019

(51) Int. Cl. G06Q 10/06; G06Q 30/02

(52) U.S. Cl. CPC G06Q 10/06315; G06Q 10/06393; G06Q 30/0207

(57) ABSTRACT

There is provided a value chain planning apparatus for a value chain from material procurement to sales of a product in which at least two or more business entities participate. The value chain planning apparatus includes an agent recruitment unit that recruits an execution module that is an agent that realizes a task included in the value chain, an agent registration unit that registers the execution module as the agent when receiving an application including the execution module, a plan preparation unit that executes the execution module for two or more tasks included in the value chain, performs a simulation of executing the task, and measures a KPI, and a reward payment processing unit that pays a reward corresponding to an execution result to the executed execution module.

### BACKGROUND OF THE INVENTION

### 1. Field of the Invention

The present invention relates to a value chain planning apparatus, a value chain planning system, and a value chain planning method.

### 2. Description of the Related Art

JP 2020-503617 A discloses “a system for multilayer charging in a cloud service broker task. The system includes at least one service vendor and at least one downstream subscriber. The service vendor is configured to provide a software service and operatively connected to a cloud service broker. The cloud service broker includes a connector that is configured to integrate a software service of the at least one service vendor, and is further configured to establish a communication provisioning channel configured to provision the integrated software service, and at least one transaction mediator configured to monitor a service transaction of the integrated software service via the connector. The downstream subscriber is operatively connected to the cloud service broker and subscribed to the integrated software service. The cloud service broker is configured to receive a price setting rule of the service vendor and a charging rule of the service vendor from each of the at least one service vendor, is further configured to receive a price setting rule of the downstream subscriber and a charging rule of the downstream subscriber from each of the at least one downstream subscriber, and is further configured to apply the price setting rule of the service vendor and the charging rule of the service vendor based at least in a part of a usage status of the integrated software service by each of the at least one downstream subscriber. The cloud service broker is further configured to calculate and adjust a payment. The payment and the adjustment are performed based on at least some of the price setting rule of the service vendor, the charging rule of the service vendor, the price setting of the subscriber, and the charging rule of the subscriber. The cloud service broker is further configured to calculate profit and loss. The profit and loss is determined by a difference between cost paid to the at least one service vendor and cost received from the at least one downstream subscriber”.

### SUMMARY OF THE INVENTION

In the technique described above in JP 2020-503617 A, the cloud service is mediated, and the service fee is distributed to a multi-layered company. There is no disclosure of planning a series of value chain tasks by combining a plurality of services.

An object of the present invention is to automatically configure a high-efficient plan for tasks included in a value chain in the designed value chain.

In order to solve the above problems, the present application adopts, for example, means described in the claims. The present invention includes a plurality of means for solving the above problems. As an example thereof, there is provided a value chain planning apparatus for a value chain from material procurement to sales of a product in which at least two or more business entities participate. The value chain planning apparatus includes an agent recruitment unit that recruits an execution module that is an agent that realizes a task included in the value chain, an agent registration unit that registers the execution module as the agent when receiving an application including the execution module, a plan preparation unit that executes the execution module registered as the agent for two or more tasks included in the value chain, performs a simulation of executing the task, and measures a KPI for a result of the simulation, and a reward payment processing unit that pays a reward corresponding to an execution result to the execution module executed in the simulation.

According to the present invention, it is possible to automatically configure a high-efficient plan for tasks included in a value chain in the designed value chain.

Objects, configurations, and advantageous effects other than those described above will be clarified by the descriptions of the following embodiments.

### BRIEF DESCRIPTION OF THE DRAWINGS

FIG. 1 is a diagram illustrating a configuration example of a value chain planning system;

FIG. 2 is a diagram illustrating an example of a data structure of VC design information;

FIG. 3 is a diagram illustrating an example of a data structure of agent information;

FIG. 4 is a diagram illustrating an example of a data structure of master information;

FIG. 5 is a diagram illustrating an example of a data structure of transaction information;

FIG. 6 is a diagram illustrating an example of a data structure of plan information;

FIG. 7 is a diagram illustrating an example of a data structure of adoption agent information;

FIG. 8 is a diagram illustrating an example of a data structure of agent evaluation information;

FIG. 9 is a diagram illustrating a hardware configuration example of a value chain planning apparatus;

FIG. 10 is a diagram illustrating an example of a flow of agent recruitment processing;

FIG. 11 is a diagram illustrating a screen example of agent recruitment;

FIG. 12 is a diagram illustrating a screen example of agent registration;

FIG. 13 is a diagram illustrating an example of a flow of planning simulation processing;

FIG. 14 is a diagram illustrating a screen example of a planning simulation instruction;

FIG. 15 is a diagram illustrating an example of a flow of task execution processing; and

FIG. 16 is a diagram illustrating an example of a flow of agent evaluation processing.

### DESCRIPTION OF THE PREFERRED EMBODIMENTS

In the following embodiment, when there is a need for convenience, the description will be made by being divided into a plurality of sections or embodiments, but unless otherwise specified, the sections or embodiments are not unrelated to each other, and one is in a relationship with some or all modification examples, details, supplementary explanation, and the like of the other.

In addition, in the following embodiment, when referring to the number of elements or the like (including the number of pieces, a numerical value, an amount, a range, and the like), the number is not limited to a specific number unless otherwise specified or obviously limited to the specific number in principle, and the number may be greater than or equal to the specific number or may be less than or equal to the specific number.

Furthermore, in the following embodiment, the components (including elements, steps, and the like) are not necessarily essential unless otherwise specified or considered to be obviously essential in principle.

Similarly, in the following embodiment, regarding the shapes, the positional relationships, and the like of the components and the like, the shapes and the like that are substantially approximate or similar to the shapes and the like are included, unless otherwise specified or considered to be obviously not in principle. The same applies to the above numerical values and ranges.

In all the drawings for describing the embodiment, the same members are denoted by the same reference signs in principle, and repetitive description thereof will be omitted. In a case where there is a high possibility of causing confusion when the same member is called as a member before being changed due to environmental change or the like, another different reference sign or name may be given. Hereinafter, an embodiment of the present invention will be described with reference to the drawings.

In recent years, not only companies but also business entities tend to be required to achieve both resilience and management efficiency. In this regard, one solution may be an open value chain starting from the customer. There is a growing social demand for Environment, Society, and Governance (ESG), and thus it is also required to realize ESG in a value chain. When a value chain is viewed in terms of a computer system, it is assumed that, by providing a system and an apparatus serving as a basis for constructing a value chain in which at least two or more business entities from material procurement to sales of a product participate, a business entity (also referred to as a participant business entity) that participates in the system and provides a value and a business entity (also referred to as an affiliated-business entity) that uses the value chain are dynamically linked.

A value chain planning system 1 according to the present invention provides a system, an apparatus, and a method serving as a basis for preparing a production/stock plan in a value chain, thereby realizing a dynamic link between a registerer (also referred to as an agent providing business entity) who provides an execution module for participating in the system and executing a task, and a business entity (also referred to as an affiliated-business entity) by using the value chain. That is, the value chain planning system 1 provides a basis for automatically configuring a high-efficient plan for tasks included in a value chain in the designed value chain. The value chain planning system 1 also provides a basis capable of satisfying a request related to ESG.

In the following embodiment, an “input unit”, an “output unit”, and a “communication unit” may be one or more interface devices. The one or more interface devices may be at least one of the following.

One or more input/output (I/O) interface devices. The I/O interface device is an interface device for at least one of an I/O device and a remote display computer. The I/O interface device for the display computer may be a communication interface device. The at least one I/O device may be any of a user interface device, for example, an input device such as a keyboard and a pointing device, and an output device such as a display device.

One or more communication interface devices. The one or more communication interface devices may be one or more communication interface devices of the same type (for example, one or more network interface cards (NICs)) or two or more communication interface devices of different types (for example, an NIC and a host bus adapter (HBA)).

In the following description, a “memory” is one or more memory devices that are an example of one or more storage devices, and may typically be a main storage device. The at least one memory device in the memory may be a volatile memory device or a non-volatile memory device.

In addition, in the following description, an “external storage device” may be one or more persistent storage devices that are an example of one or more storage devices. Typically, the persistent storage device may be a non-volatile storage device (for example, an auxiliary storage device), and specifically, for example, may be a hard disk drive (HDD), a solid state drive (SSD), a non-volatile memory express (NVME) drive, or a storage class memory (SCM).

In the following description, a “storage unit” or the “external storage device” may be a memory or both of a memory and a persistent storage device.

In the following description, a “processing unit” or a “processor” may be one or more processor devices. The at least one processor device may typically be a microprocessor device such as a central processing unit (CPU), but may be another type of processor device such as a graphics processing unit (GPU). The at least one processor device may be a single core or a multi-core. The at least one processor device may be a processor core. The at least one processor device may be a processor device in a broad sense such as a circuit (for example, a field-programmable gate array (FPGA), a complex programmable logic device (CPLD), or an application specific integrated circuit (ASIC)) that is an aggregate of gate arrays in a hardware description language that performs a portion or the entirety of processing.

In following description, a “value chain planning system” may be a system including one or more physical computers, or may be a system (for example, a cloud computing system) realized on a physical calculation resource group (for example, a cloud infrastructure). The value chain planning system “displaying” information for display may mean that the information for display is displayed on a display device of a computer, or that the computer transmits the information for display to the computer for display (in the latter case, the information for display is displayed by the computer for display).

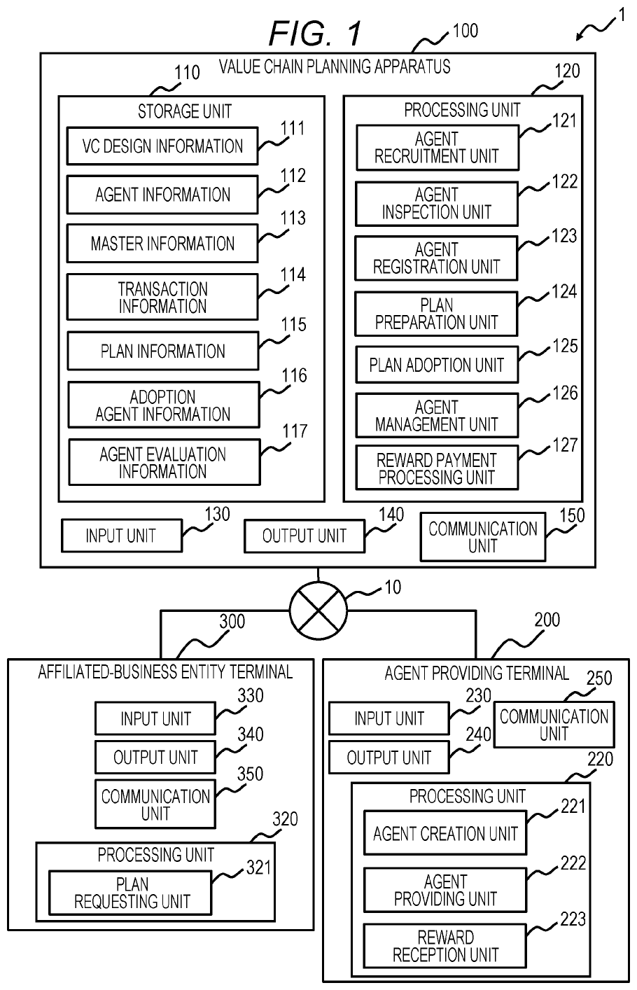

FIG. 1 is a diagram illustrating a configuration example of the value chain planning system. A value chain planning system 1 includes a value chain planning apparatus 100, an agent providing terminal 200, an affiliated-business entity terminal 300, and a network 10 that communicably connects the terminals to each other. The value chain planning system 1 includes a device group corresponding to a use environment such as a display computer communicably connected via the network 10.

The network 10 is, for example, any one or a combination of a communication network using a portion or the entirety of a general public line such as a local area network (LAN), a wide area network (WAN), a virtual private network (VPN), the Internet, and the like, a portable phone communication network, and the like. The network 10 may be a wireless communication network such as Wi-Fi (registered trademark) or 5G (Generation).

The value chain planning apparatus 100 is a processing apparatus including a storage unit 110, a processing unit 120, an input unit 130, an output unit 140, and a communication unit 150. The storage unit 110 includes value chain (VC) design information 111, agent information 112, master information 113, transaction information 114, plan information 115, adoption agent information 116, and agent evaluation information 117.

The processing unit 120 includes an agent recruitment unit 121, an agent inspection unit 122, an agent registration unit 123, a plan preparation unit 124, a plan adoption unit 125, an agent management unit 126, and a reward payment processing unit 127.

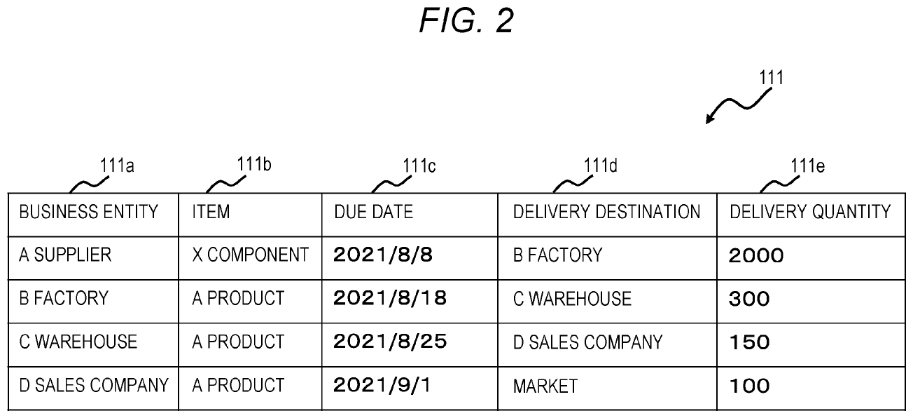

FIG. 2 is a diagram illustrating an example of a data structure of the VC design information. The VC design information 111 includes at least a combination of participant business entities that satisfy the demand included in a transaction. Specifically, the VC design information 111 includes a business entity 111a including a participant business entity participating in a value chain or an affiliated-business entity that performs procurement by using the value chain, a related item 111b, a due date 111c as a delivery date to a downstream business entity, a delivery destination 111d being a delivery destination on the due date 111c, and a delivery quantity 111e being a delivery amount.

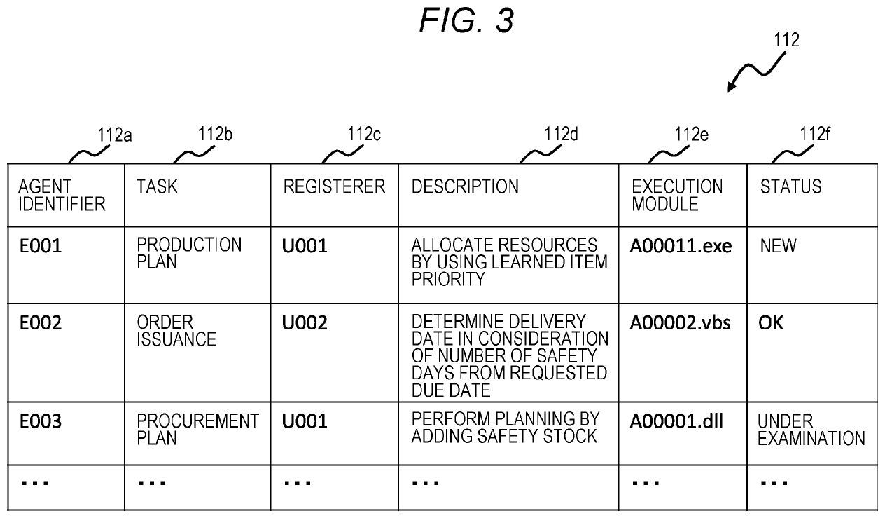

FIG. 3 is a diagram illustrating an example of a data structure of the agent information. In the agent information 112, an execution module which is an agent that realizes the task included in the value chain is registered. Specifically, the agent information 112 includes an agent identifier 112a for identifying an agent, a task 112b executed by the agent, a registerer 112c being a person who has registered the agent in the value chain planning system, a description 112d which is caption information of the agent, an execution module 112e which is an executable computer program as an actual form of the agent, and a status 112f indicating a registration state.

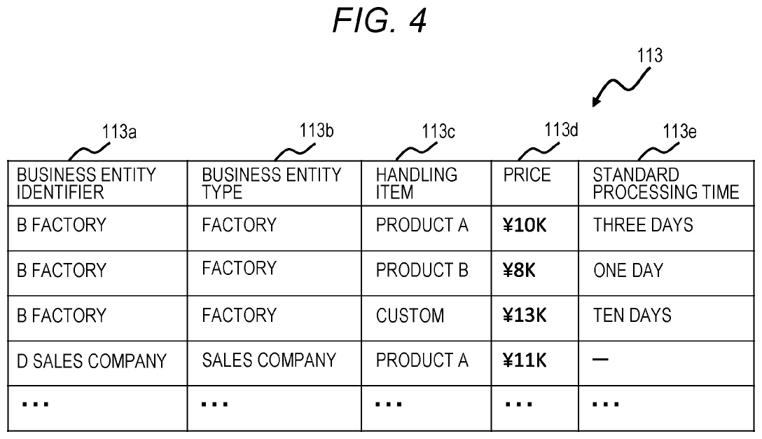

FIG. 4 is a diagram illustrating an example of a data structure of the master information. The master information 113 stores at least a providable value, cost of the value, and a provision lead time of the value in association with each other, for each business entity participating in or being affiliated in the value chain.

In the master information 113, for each business entity identifier 113a, a business entity type 113b, a handling item 113c, a price 113d, and a standard processing time 113e are stored in association with each other.

Information specifying a company or the like (business entity) desiring participation/affiliation in various value chains to be established is stored in the business entity identifier 113a. The business entity type 113b stores a type of value provided by the business entity specified by the business entity identifier 113a. Examples of the type of the business entity include a sales company, a warehouse, a manufacturing industry (factory), a transportation industry, a supplier, and the like.

A specific item of the value provided by the business entity specified by the business entity identifier 113a is stored in the handling item 113c. The price of the specific item of the value provided by the business entity specified by the business entity identifier 113a is stored in the price 113d. A specific standard lead time (standard period from order placement to delivery) of the value provided by the business entity specified by the business entity identifier 113a is stored in the standard processing time 113e. The information stored in the standard processing time 113e is information necessary for constructing the value chain, but is also information to be kept secret except for the business entity itself, and thus is stored with predetermined encryption. In addition, the master information 113 may include information corresponding to a plurality of pieces of task information.

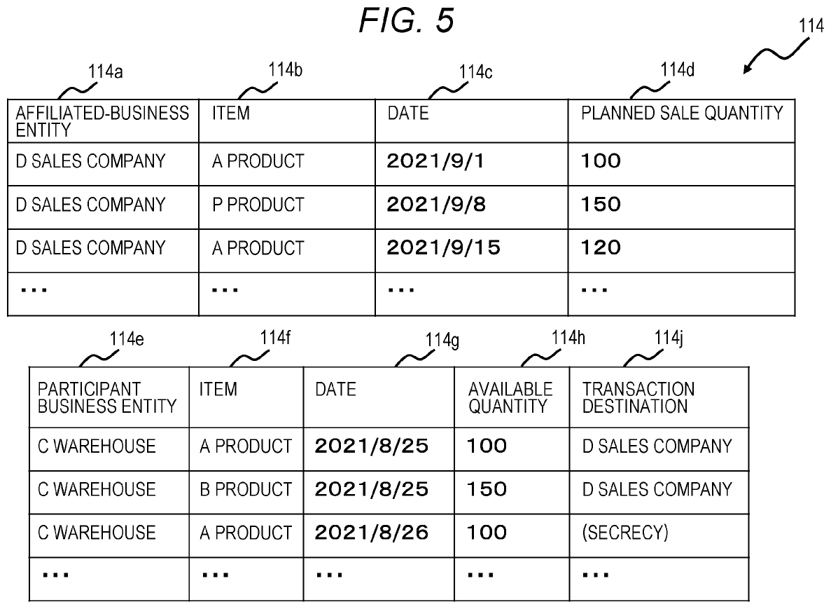

FIG. 5 is a diagram illustrating an example of a data structure of the transaction information. The transaction information 114 includes transaction data for which a value chain is planned. Specifically, demand information including an affiliated-business entity 114a, an item 114b specifying a value procured by the affiliated-business entity, a date 114c indicating a delivery date, and a planned sale quantity 114d that is a required amount is stored in the transaction information 114.

In addition, supply information including a participant business entity 114e, an item 114f specifying a value provided by the participant business entity, a date 114g indicating a delivery date, an available quantity 114h, and a transaction destination 114j indicating a provision destination is stored in the transaction information 114. Since the transaction destination 114j is also information to be kept secret except for the transaction destination and the participant business entity itself, the information is stored with predetermined encryption.

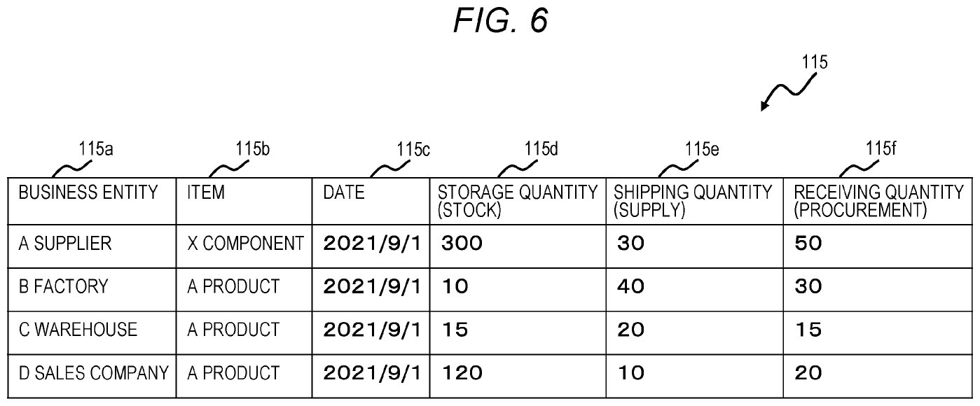

FIG. 6 is a diagram illustrating an example of a data structure of the plan information. Plan information of a value chain as information obtained as a result of executing a task business by the agent is stored in the plan information 115. Specifically, the plan information 115 includes a business entity 115a including a participant business entity participating in the value chain or an affiliated-business entity that performs procurement by using the value chain, a related item 115b, a date 115c, a storage quantity 115d forming a receiving/shipping state of the business entity on the date 115c, a shipping quantity 115e, and a receiving quantity 115f.

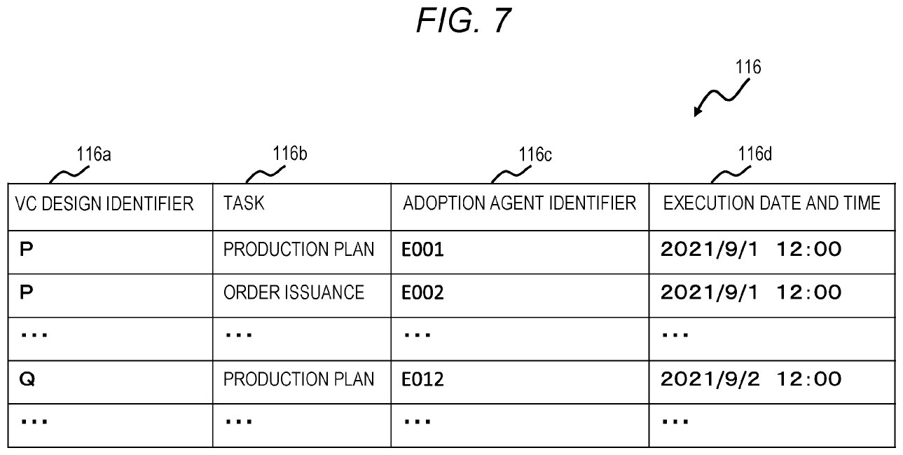

FIG. 7 is a diagram illustrating an example of a data structure of the adoption agent information. In the adoption agent information 116, a VC design identifier 116a specifying a value chain executed including a simulation, a task 116b executed in the designed value chain, an adoption agent identifier 116c specifying an agent adopted in the execution, and an execution date and time 116d that specifies a date and time when the execution has been performed are stored in association with each other.

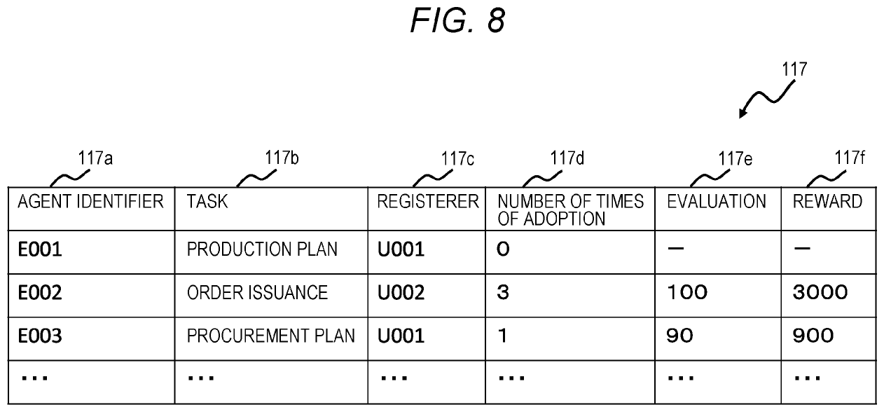

FIG. 8 is a diagram illustrating an example of a data structure of the agent evaluation information. The agent evaluation information 117 stores an agent identifier 117a specifying an agent, a task 117b executed in the designed value chain, a registerer 117c being a person who has registered the agent in the value chain planning system, the number of times of adoption 117d that is the number of times that the agent is to be executed in an evaluation aggregation target period, an evaluation 117e that is an evaluation from an affiliated business company in the evaluation aggregation target period or an evaluation based on various indexes, and a reward 117f that is a total reward amount in the evaluation aggregation target period in association with each other.

The evaluation 117e includes various evaluation points. Examples of the evaluation points include (A) an ESG evaluation of an affiliated business operator adopted for a task (further, for example, DJSI: Dow Jones sustainability index), (B) a financial evaluation of an affiliated business operator adopted for a task (further, for example, ROE: return on equity), (C) customer satisfaction of a member business operator employed for a task, (D) rating of an affiliated business operator adopted for a task (further, for example, S&P issuance sizing), (E) a feedback evaluation from an affiliated business operator adopted for a task, and (F) a predetermined key performance indicator (KPI) improvement of an affiliated business operator adopted for a task. However, the embodiment is not limited thereto, and other evaluation points may be included. In particular, the ESG evaluation may be not only the ESG evaluation as an index related to investment but also an evaluation of sustainable development goals (SDGs) or an evaluation of each of environment, society, and governance.

Alternatively, the evaluation point included in the evaluation 117e may be a value calculated by a predetermined evaluation expression using any one of the evaluation points (A) to (F) or a combination thereof. Such an evaluation expression is desirably an evaluation expression corresponding to the task executed by the agent. An evaluation point calculation algorithm may be, for example, set to be an evaluation point obtained in a manner that each of the evaluation points (A) to (F) is calculated on a scale of 100 points, and a weighting coefficient corresponding to the task is applied to each evaluation point. This is because different tasks may have different evaluation points to be prioritized.

For example, in the case of an agent in a value chain constituted by a business entity with high evaluation regarding the environment, society, and governance, a weight can be placed on the ESG evaluation of (A).

The description returns to FIG. 1. The agent recruitment unit 121 recruits an execution module that is an agent that realizes a task included in a value chain.

At the time of execution of the agent registration unit 123, the agent inspection unit 122 inspects the applied execution module in the secure environment, and determines that the behavior is correct and safe.

Upon receiving an application including the execution module, the agent registration unit 123 registers the execution module as an agent. In addition, the agent registration unit 123 causes the agent inspection unit 122 to inspect the applied execution module, and registers the execution module as the agent when the behavior is correct and safe. In addition, the agent registration unit 123 receives the application when the execution module is at least a program file in various executable formats.

The plan preparation unit 124 performs a simulation of executing the execution module registered as the agent for two or more tasks included in the value chain to execute the tasks, and measures a KPI for a result of the simulation. The plan preparation unit 124 displays the agent adopted in each simulation. The plan preparation unit 124 displays a result of the simulation for each simulation so that the affiliated-business entity can select any result.

The plan preparation unit 124 may preferentially assign an agent with a high evaluation among agents corresponding to the tasks of the value chain.

Alternatively, the plan preparation unit 124 may give a priority to an agent having a high evaluation regarding a predetermined rating, or may give a priority to an agent having a high evaluation from the affiliated-business entity.

When receiving the selection of the result of the simulation displayed by the plan preparation unit 124, the plan adoption unit 125 associates the agent assignment in the simulation with the VC.

The agent management unit 126 logs an execution result on the execution module executed in the simulation, and calculates a reward corresponding to the execution result in a predetermined evaluation period.

The reward payment processing unit 127 pays a reward corresponding to the execution result to the registerer of the agent for the execution module executed in the simulation. The reward payment processing unit 127 increases the reward as the number of times of executing the execution module increases. The reward payment processing unit 127 pays the reward in accordance with the evaluation regarding the environment, society, and governance of the affiliated-business entity in the value chain including a task for which the execution module has been executed. In addition, the reward payment processing unit 127 pays the reward in accordance with a predetermined KPI of the affiliated-business entity in the value chain including the task for which the execution module has been executed.

The input unit 130 is displayed and operated on a screen, for example, and receives input information operated and input by a keyboard or a mouse.

For example, the output unit 140 creates screen information including information to be output as a result of performing predetermined processing, and outputs the screen information to the display computer.

The communication unit 150 communicates with other devices via the network 10. For example, the communication unit 150 is communicably connected to an agent providing terminal 200 mainly used by an agent providing entity (registerer) or an affiliated-business entity terminal 300 mainly used by an affiliated-business entity.

The agent providing terminal 200 and the affiliated-business entity terminal 300 are basically similar terminals. The affiliated-business entity terminal 300 can act not only as an affiliated-business entity but also as the agent providing terminal 200 when an agent providing entity (registerer) acts as an affiliated-business entity.

The agent providing terminal 200 includes a processing unit 220, an agent creation unit 221, an agent providing unit 222, and a reward reception unit 223, and further includes an input unit 230, an output unit 240, and a communication unit 250. The agent creation unit 221, the agent providing unit 222, and the reward reception unit 223 are portions of the processing unit 220.

The agent creation unit 221 implements a function for creating a program file, which is the execution module that executes the task as the agent. For example, it is an integrated development environment of software.

The agent providing unit 222 transmits, to the value chain planning apparatus 100, information including the execution module created by the agent creation unit 221 or the like, thereby making an application as an agent that realizes the task included in the value chain.

The reward reception unit 223 receives a reward paid by execution of the agent from the value chain planning apparatus 100 at a predetermined timing, periodically, or intermittently.

The input unit 230 is displayed and operated on a screen, for example, and receives input information operated and input by a keyboard or a mouse.

For example, the output unit 240 creates screen information including information to be output as a result of performing predetermined processing, and outputs the screen information to the display computer.

The communication unit 250 communicates with other devices via the network 10. For example, the communication unit 250 is communicably connected to the value chain planning apparatus 100 or the affiliated-business entity terminal 300 mainly used by the affiliated-business entity.

The affiliated-business entity terminal 300 includes a processing unit 320, a plan requesting unit 321 that is a portion of the processing unit 320, an input unit 330, an output unit 340, and a communication unit 350.

The plan requesting unit 321 includes an Internet browser or the like. The plan requesting unit 321 transmits a request for planning the value chain and input information to the value chain planning apparatus 100, and receives output information such as a screen display from the value chain planning apparatus 100.

The input unit 330 is displayed and operated on a screen, for example, and receives input information operated and input by a keyboard or a mouse.

For example, the output unit 340 creates screen information including information to be output as a result of performing predetermined processing, and outputs the screen information to the display computer.

The communication unit 350 communicates with other devices via the network 10. For example, the communication unit 350 is communicably connected to the value chain planning apparatus 100 or the agent providing terminal 200 mainly used by the agent providing entity (registerer).

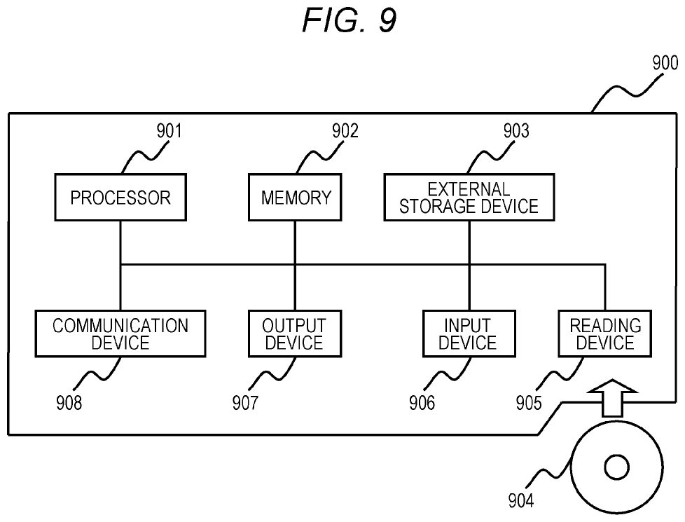

FIG. 9 is a diagram illustrating a hardware configuration example of the value chain planning apparatus. The value chain planning apparatus 100 can be realized by a general computer 900 or a network system including a plurality of the computers 900. The general computer 900 includes a processor (for example, a CPU or a GPU) 901, a memory 902 such as a random access memory (RAM), an external storage device 903 such as a hard disk device (HDD) or an SSD, a reading device 905 that reads information from a portable storage medium 904 such as a CD or a DVD, an input device 906 such as a keyboard, a mouse, a bar code reader, or a touch panel, an output device 907 such as a display, and a communication device 908 that communicates with another computer via a communication network such as a LAN or the Internet. The reading device 905 may be capable of not only reading the portable storage medium 904 but also performing writing.

For example, the agent recruitment unit 121, the agent inspection unit 122, the agent registration unit 123, the plan preparation unit 124, the plan adoption unit 125, the agent management unit 126, and the reward payment processing unit 127 in the processing unit 120 can be implemented by loading a predetermined program stored in the external storage device 903 into the memory 902 and executing the program with the processor 901. The input unit 130 can be implemented by the processor 901 using the input device 906. The output unit 140 can be implemented by the processor 901 using the output device 907 or the communication device 908. The communication unit 150 can be implemented by the processor 901 using the communication device 908. The storage unit 110 can be implemented by the processor 901 using the memory 902 or the external storage device 903.

The predetermined program may be downloaded to the external storage device 903 from the portable storage medium 904 via the reading device 905 or from the network via the communication device 908, and then may be loaded onto the memory 902 and executed by the processor 901. Furthermore, the program may be directly loaded onto the memory 902 from the portable storage medium 904 via the reading device 905 or from the network via the communication device 908 and executed by the processor 901. The embodiment is not limited thereto. The value chain planning apparatus 100 may be, for example, a wearable computer worn by an operator, such as a headset, goggles, glasses, or an intercom.

The agent providing terminal 200 and the affiliated-business entity terminal 300 are basically information processing apparatuses similar to the value chain planning apparatus 100.

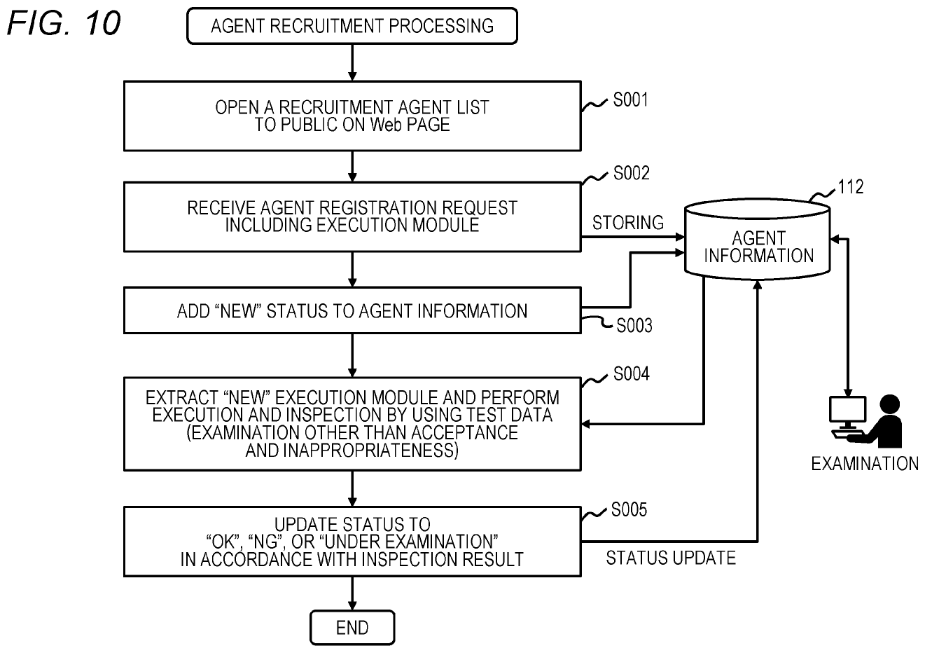

FIG. 10 is a diagram illustrating an example of a flow of agent recruitment processing. The agent recruitment processing is started when the value chain planning apparatus 100 receives a start instruction from a user via the interface device.

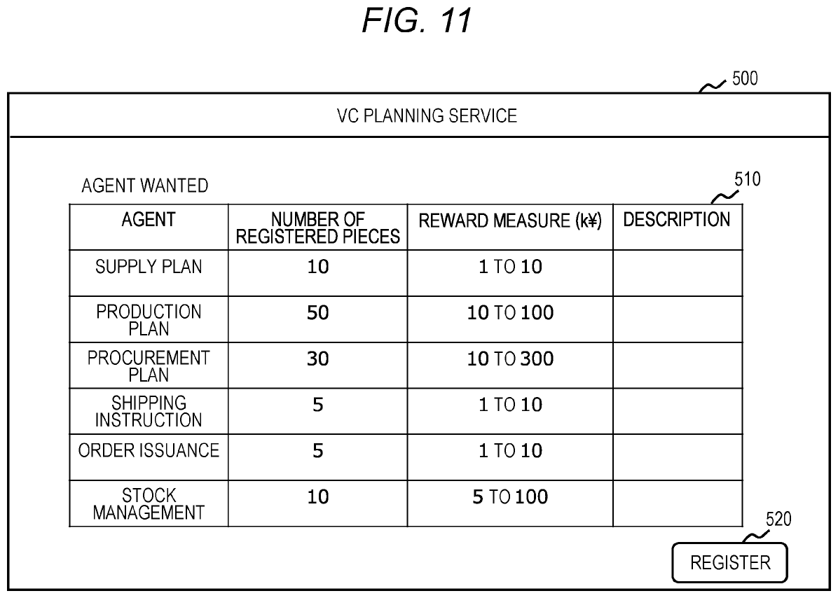

First, the agent recruitment unit 121 opens a recruitment agent list to the public on a Web page or the like (Step S001). Specifically, the agent recruitment unit 121 generates a Web page having the display information illustrated in FIG. 11, and discloses a task of an agent to be recruited, the number of registrations, a reward guidance, and the like by Hyper Text Transfer Protocol Secure (HTTPS) or the like.

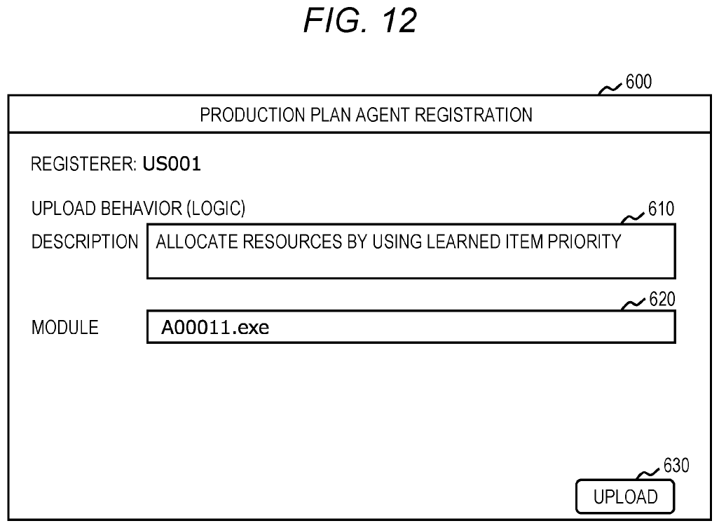

FIG. 11 is a diagram illustrating a screen example of agent recruitment. A VC planning service screen 500, which is a screen example of agent recruitment, includes, for each agent that performs recruitment, a recruitment list 510 and a registration button 520. The recruitment list 510 includes the number of registrations, which is the number of recruitments, a reward guidance, and a description of a task to be executed by the agent. The registration button 520 receives an input for transition to a screen for a registration procedure of any agent. The registerer who provides the agent browses the VC planning service screen 500 by using the agent providing unit 222 of the agent providing terminal 200, and recognizes the agent to be created. Then, the registerer makes an input to the registration button 520 of the VC planning service screen 500 by using the agent providing unit 222, thereby causing the screen to transition to a production plan agent registration screen 600 illustrated in FIG. 12. Then, the registerer makes an application for the execution module of the agent created via the agent creation unit 221 by using the agent providing unit 222.

FIG. 12 is a diagram illustrating a screen example of agent registration. The production plan agent registration screen 600, which is a screen example of the agent registration, includes a description input field 610 related to the behavior of the agent, an execution module input field 620, and an upload button 630. The description input field 610 receives, as a free text, an input of a sentence describing the feature of the function or operation of the execution module of the agent in natural language. The execution module input field 620 receives an input of a file path and a file name of the execution module. When receiving the input, the upload button 630 receives information input in the description input field 610 and the execution module input field 620, and performs application including the file having the file name input in the execution module input field 620.

The agent recruitment unit 121 receives an agent registration request (application) including the execution module (Step S002). Specifically, the agent recruitment unit 121 receives the application of the execution module of the agent from the agent providing unit 222 via the production plan agent registration screen 600. The agent recruitment unit 121 stores the execution module that has been applied, the free text of the description of the agent, and the registerer in the agent information 112 in association with the task.

The agent registration unit 123 gives a status of “new” to the agent information (Step S003). Specifically, the agent registration unit 123 sets “new” to the status 112f of the agent information 112 regarding the agent stored in Step S002.

Then, the agent inspection unit 122 extracts a “new” execution module, and performs an inspection by executing the extracted execution module using test data (Step S004). Specifically, the agent inspection unit 122 refers to the agent information 112 to extract an execution module of which the status 112f is “new”, and execute the extracted execution module in a predetermined secure test environment (environment in which the execution of the execution module in a test environment does not affect other environments) such as an emulator or a virtual machine by using dummy data. The agent inspection unit 122 inspects whether there is a predetermined security standard violation in behavior or the like during the execution, or correctness and certainty of an execution result, in accordance with predetermined inspection criteria. It is assumed that the predetermined inspection criteria are set in accordance with a use environment and the policy, and the agent inspection unit 122 performs the inspection in accordance with the inspection criteria.

The agent inspection unit 122 determines that the behavior is passed when the behavior of a target execution module is correct and safe as a result of the inspection, and determines the inspection result to be inappropriate when the behavior is incorrect or there is a clear problem in security. In a case where the execution is interrupted due to the occurrence of an error or the like, or in a case where it is not possible to determine the pass or inappropriateness, the agent inspection unit 122 passes the execution module to the person in charge of examination, receives the determination of the person in charge of examination, and uses the result as the inspection result.

Then, the agent registration unit 123 updates the status to “OK”, “NG”, or “under examination” in accordance with the inspection result of the execution module (Step S005). Specifically, the agent registration unit 123 sets “OK” to the status 112f when the determination of the inspection result by the agent inspection unit 122 is “pass”, sets “NG” to the status 112f when the determination of the inspection result is “inappropriateness”, and sets “under examination” to the status 112f when the determination of the inspection result is under examination.

The flow of the agent recruitment processing has been described above. According to the agent recruitment processing, it is possible to perform recruitment of execution modules as agents, reception of applications, and examination by inspection. In addition, in the examination, the execution module of the agent only needs to be in an execution form that operates on a computer, and does not require disclosure of another source code. This is not applied to a case where execution codes are created by a programming language (VBScript, JavaScript, Python, or the like) that requires the source code during the execution. As a result, the registerer who needs to keep the source code of the execution module secret can make an application of the agent while keeping the source code secret, by creating the execution module using the compiled language.

With such agent recruitment processing and screen transition, a business entity that desires to apply an agent can not only easily make an application, but also ensure diversity of values provided by a value chain and secure resilience.

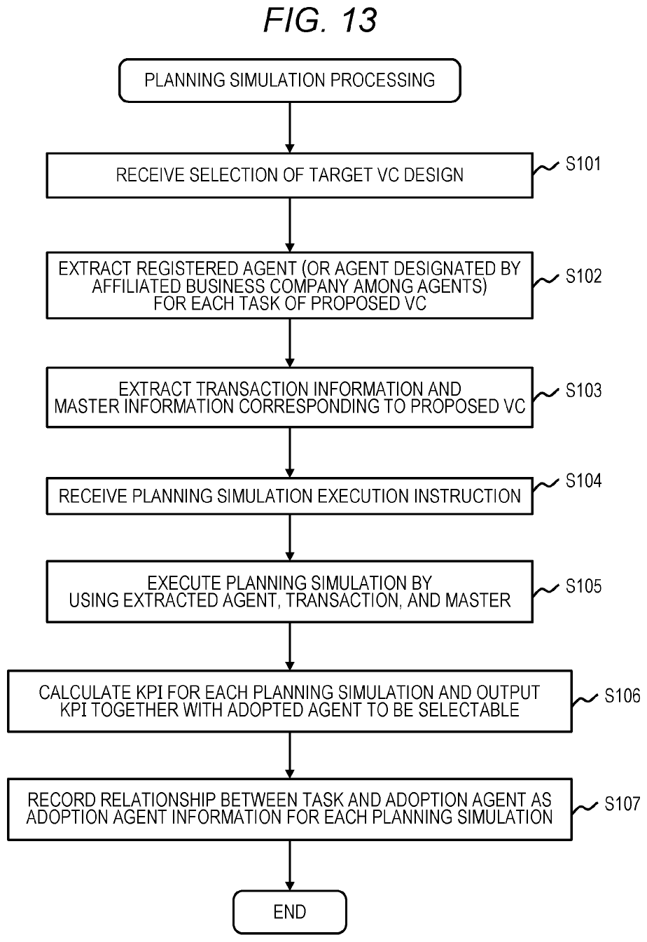

FIG. 13 is a diagram illustrating an example of a flow of planning simulation processing. The planning simulation process is started when the affiliated-business entity accesses the value chain planning apparatus 100 by using the affiliated-business entity terminal 300.

First, the plan preparation unit 124 receives selection of a VC design to be planned (Step S101). Specifically, the plan preparation unit 124 refers to the VC design information 111 to selectably display a list of VC designs included in the affiliated-business entity terminal 300 by the affiliated-business entity, and to receive selection from the affiliated-business entity terminal 300.

Then, the plan preparation unit 124 extracts an agent registered for each task of a VC draft (or an agent designated by the affiliated business operator among the agents) (Step S102). Then, the plan preparation unit 124 extracts the transaction information 114 and the master information 113 related to the related business entity for a period corresponding to the VC draft (Step S103).

Then, the plan preparation unit 124 receives a planning simulation execution instruction (Step S104). Specifically, the plan preparation unit 124 receives an instruction to execute a planning simulation from the affiliated-business entity terminal 300.

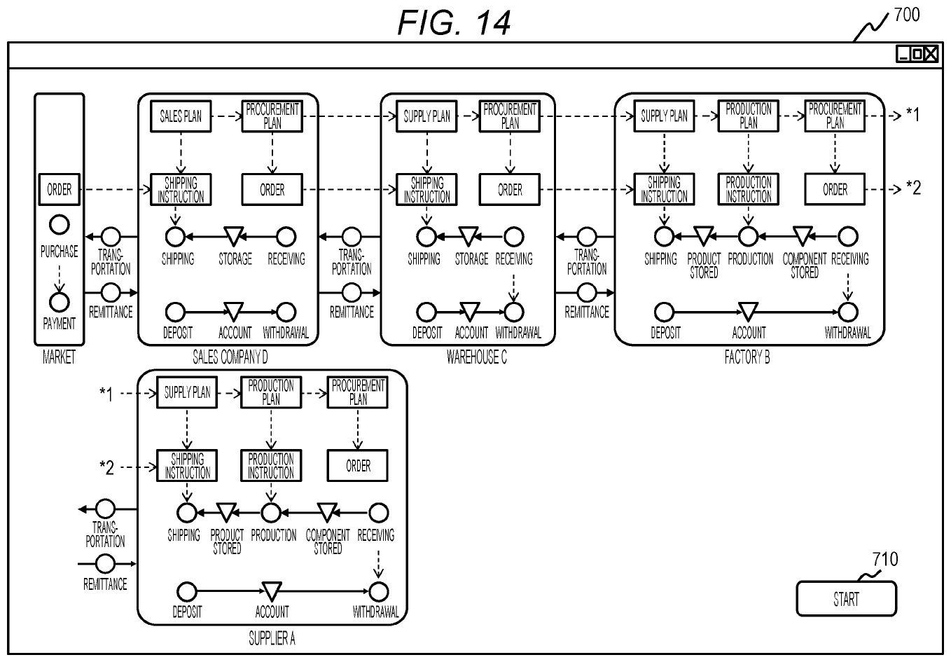

FIG. 14 is a diagram illustrating a screen example of a planning simulation instruction. A planning simulation instruction screen 700, which is a screen example of the planning simulation instruction, schematically shows the constituent business entity of the VC design to be the planning simulation target and the outline of the internal task, and includes a start button 710 for receiving a planning simulation start instruction. In the schematic diagram, when an input to an icon indicating each task is received, agents that are candidates for executing the task are listed.

Then, the plan preparation unit 124 executes a planning simulation by using the extracted agent, transaction, and master (Step S105). Specifically, in accordance with the VC design information 111, the plan preparation unit 124 executes the planning simulation of the entire VC a plurality of times by changing the combination of agents of each task on the premise of a sales plan, the delivery quantity, and the delivery date and time of the constituent business entity. The plan preparation unit 124 stores an execution result in the plan information 115 each time each planning simulation is executed.

Then, the plan preparation unit 124 calculates a predetermined KPI for each planning simulation and outputs the predetermined KPI together with the adopted agent (Step S106). Specifically, the plan preparation unit 124 evaluates the result of the planning simulation executed in Step S105 by a predetermined KPI evaluation method. For the calculation of the KPI, a known algorithm can be used. Then, the plan preparation unit 124 selectably displays the KPI and the agent adopted for each task together with the planning simulation result, on the affiliated-business entity terminal 300.

Then, the agent management unit 126 records the relationship between the task and the adoption agent as the adoption agent information for each planning simulation (Step S107). Specifically, the agent management unit 126 stores the VC design identifier, the task, the agent identifier adopted in the task, and the execution date and time in the VC design identifier 116a, the task 116b, the adoption agent identifier 116c, and the execution date and time 116d in the adoption agent information 116, in association with each other for each task included in the VC design of the planning simulation target.

The flow of the planning simulation processing has been described above. According to the planning simulation processing, in the designed value chain, it is possible to specifically obtain, in a selectable state, information as a determination material for selecting an agent that executes a task of automatically configuring a high-efficient plan, for a task included in the value chain.

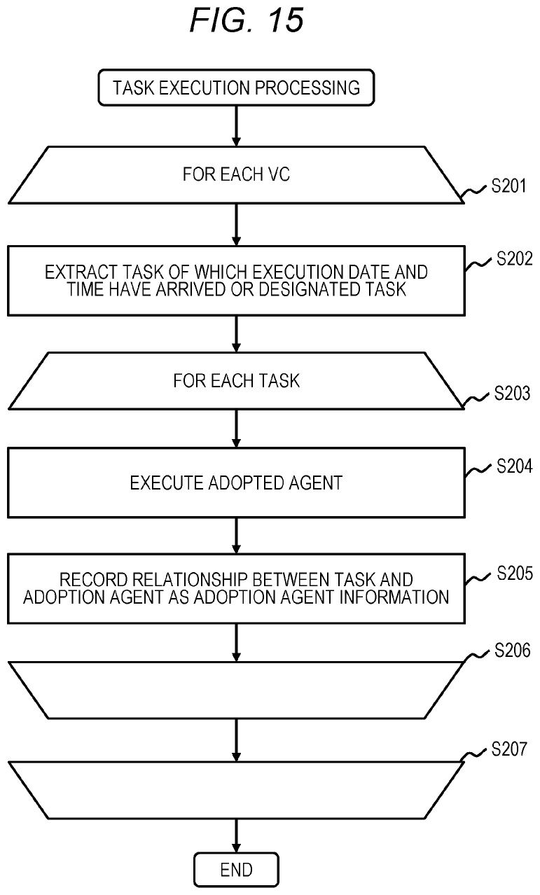

FIG. 15 is a diagram illustrating an example of a flow of task execution processing. The task execution processing is started when the affiliated-business entity accesses the value chain planning apparatus 100 by the plan requesting unit 321 of the affiliated-business entity terminal 300 and selects and inputs a planning simulation to be executed from a result screen of the planning simulation processing.

First, the plan adoption unit 125 repeats the processes of Steps S202 to S206 described later for each designated VC design among VC designs of affiliated-business entities (Steps S201 and S207).

The plan adoption unit 125 extracts the task of which the execution date and time has arrived or the task designated by the affiliated-business entity, as the task to be executed (Step S202).

Then, the plan adoption unit 125 repeats the processes of Steps S204 and S205 described later in a normal order or the reverse order of tasks constituting the VC, for each of the extracted tasks (Steps S203 and S206).

The plan adoption unit 125 executes the adopted agent (Step S204). Specifically, the plan adoption unit 125 starts the execution module adopted as the agent that executes the target task. For example, when the execution module is a compiled binary file, processing is started, and, when the execution module is a text file such as a script, processing is started by constructing a runtime environment.

Then, the agent management unit 126 records the relationship between the executed task and the adoption agent, as the adoption agent information (Step S205). Specifically, the agent management unit 126 stores the VC design identifier, the task, the agent identifier adopted in the task, and the execution date and time in the VC design identifier 116a, the task 116b, the adoption agent identifier 116c, and the execution date and time 116d in the adoption agent information 116, in association with each other for each task included in the VC design of the execution target.

The flow of the task execution processing has been described above. According to the task execution processing, it is possible to automatically execute the task at a predetermined timing by using the selected agent. For example, it is possible to cause the agent to automatically execute a task of creating a production plan in accordance with an item to be delivered weekly according to a VC design and a delivery amount.

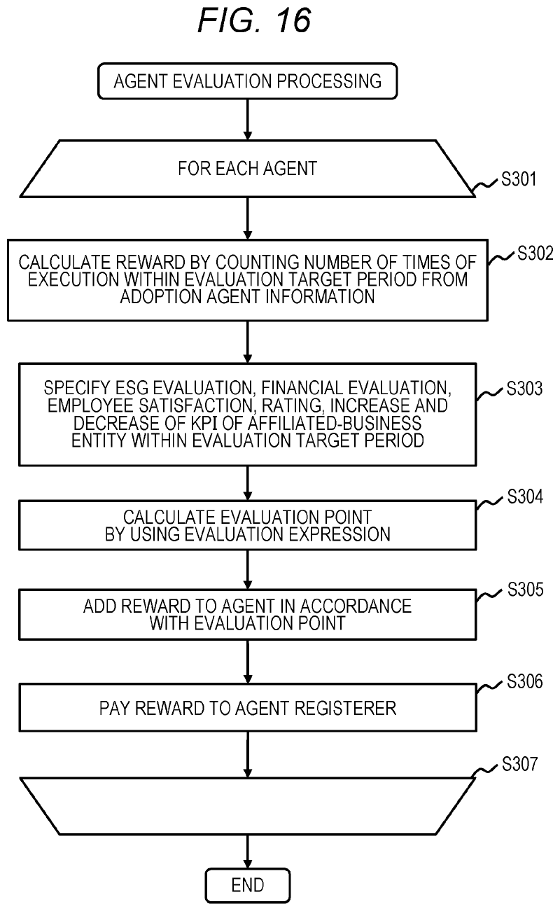

FIG. 16 is a diagram illustrating an example of a flow of agent evaluation processing. The agent evaluation processing is intermittently started, for example, at a predetermined date and time (for example, the last day of each month or the like) every month or for a predetermined period (for example, 7 days).

First, the agent management unit 126 repeats processes of Steps S302 to S306 to be described later for each of all registered agents (Step S301 and Step S307).

The agent management unit 126 calculates a reward by counting the number of times of execution within the evaluation target period from the adoption agent information 116 (Step S302). Specifically, the agent management unit 126 refers to the adoption agent information 116 to count the number of times of execution of the target agent for the execution of which the execution date and time 116d is included in the evaluation target period, and to calculate the reward by using the number of times of execution as the number of times of adoption. Then, the agent management unit 126 stores the number of times of adoption of the agent in the number of times of adoption 117d of the agent evaluation information 117.

Then, the agent management unit 126 specifies an increase or decrease in ESG evaluation, financial evaluation, employee satisfaction level, rating, and KPI of the affiliated-business entity within the evaluation target period (Step S303). Specifically, the agent management unit 126 refers to the adoption agent information 116 to specify the VC design identifier 116a for the execution of the target agent of which the execution date and time 116d is included in the evaluation target period. Then, the affiliated-business entity of the VC related to the specified VC design identifier is specified from the VC design information 111, and information such as the ESG evaluation, the financial evaluation, the employee satisfaction level, the rating, and the increase and decrease of the KPI of the affiliated-business entity is acquired with reference to the evaluation information provided by an external organization that handles economic information.

Then, the agent management unit 126 calculates an evaluation point by using the evaluation expression (Step S304). Specifically, the agent management unit 126 substitutes the evaluation information specified in Step S303 into a predetermined evaluation expression to calculate the evaluation point of the target affiliated-business entity. Then, the agent management unit 126 sums the evaluation points of the affiliated-business entities related to the VC design executed within the evaluation target period. Then, the agent management unit 126 stores the evaluation point of the agent in the evaluation 117e of the agent evaluation information 117.

Then, the agent management unit 126 adds a reward to the agent in accordance with the evaluation point (Step S305). Specifically, the reward payment processing unit 127 adds the reward corresponding to the evaluation point calculated in Step S304 to the reward calculated in Step S302, and stores the total reward of the agent in the reward 117f of the agent evaluation information 117.

Then, the reward payment processing unit 127 pays the reward to the agent registerer (Step S306). Specifically, the reward payment processing unit 127 performs processing of paying the reward to the reward reception unit 223 of the registerer via a bank account or a predetermined settlement institution, for example, transfer processing.

The example of the flow of the agent evaluation processing has been described above. According to the flow of the agent evaluation processing, it is possible to determine a reward for each agent by using the reward based on the number of times of execution and the reward based on the evaluation of the affiliated-business entity of the VC related to the executed task, and to pay the reward to the agent registerer.

The configuration of the value chain planning system 1 according to the embodiment has been described above. According to the value chain planning system 1, it is possible to automatically configure a high-efficient plan for tasks included in a value chain in the designed value chain.

The present invention is not limited to the above embodiment, and various modification examples may be provided. The above embodiment has been described in detail in order to explain the present invention in an easy-to-understand manner, and the above embodiment is not necessarily limited to a case including all the described configurations. A part of the configuration of the embodiment can be replaced with another configuration. A part of the configuration of the embodiment can be deleted.

Some or all of the units, the configurations, the functions, the processing units, and the like described above may be realized in hardware by being designed with an integrated circuit, for example. Further, the units, the configurations, the functions, and the like described above may be realized by software by the processor interpreting and executing a program for realizing the respective functions. Information such as a program, a table, and a file, that realizes each function can be stored in a memory, a recording device such as a hard disk, or a storage medium such as an IC card, an SD card, and a DVD.

In the above-described embodiment, the control lines and the information lines considered necessary for the descriptions are illustrated, and not all the control lines and the information lines in the product are necessarily shown. In practice, it may be considered that almost all components are connected to each other. Hitherto, the present invention has been described focusing on the embodiment.

What is claimed is:

1. A value chain planning apparatus for a value chain from material procurement to sales of a product in which at least two or more business entities participate, the value chain planning apparatus comprising:
an agent recruitment unit that recruits an execution module that is an agent that realizes a task included in the value chain;
an agent registration unit that registers the execution module as the agent when receiving an application including the execution module;
a plan preparation unit that executes the execution module registered as the agent for two or more tasks included in the value chain, performs a simulation of executing the task, and measures a KPI for a result of the simulation; and
a reward payment processing unit that pays a reward corresponding to an execution result to the execution module executed in the simulation.

2. The value chain planning apparatus according to claim 1, wherein the plan preparation unit displays an agent adopted in the simulation for each simulation.

3. The value chain planning apparatus according to claim 1, wherein
the plan preparation unit displays the result of the simulation for each simulation, and
an affiliated-business entity is capable of selecting any of the results.

4. The value chain planning apparatus according to claim 1, wherein the reward payment processing unit increases the reward when the number of times of execution of the execution module increases.

5. The value chain planning apparatus according to claim 1, wherein the reward payment processing unit pays the reward in accordance with an evaluation regarding an environment, a society, and a governance of an affiliated-business entity in the value chain including a task for which the execution module is executed.

6. The value chain planning apparatus according to claim 1, wherein the reward payment processing unit pays the reward in response to a predetermined KPI of the affiliated-business entity in the value chain including the task for which the execution module is executed.

7. The value chain planning apparatus according to claim 1, wherein the agent registration unit registers, as the agent, an execution module of which a behavior is correct and safe among the applied execution modules inspected in a secure environment.

8. The value chain planning apparatus according to claim 1, wherein the agent registration unit receives an application of the execution module when the execution module is at least a program file in various executable formats.

9. A value chain planning system for a value chain from material procurement to sales of a product in which at least two or more business entities participate, the value chain planning system comprising:
an agent recruitment unit that recruits an execution module that is an agent that realizes a task included in the value chain;
an agent providing unit that performs an application including the execution module;
an agent registration unit that registers the execution module as the agent when receiving the application including the execution module;
a plan preparation unit that executes the execution module registered as the agent for two or more tasks included in the value chain, performs a simulation of executing the task, and measures a KPI for a result of the simulation;
a reward payment processing unit that pays a reward corresponding to an execution result to the execution module executed in the simulation; and
a reward reception unit that receives the reward.

10. A value chain planning method for a value chain from material procurement to sales of a product in which at least two or more business entities participate, the value chain planning method comprising:
recruiting an execution module that is an agent that realizes a task included in the value chain;
performing an application including information including the execution module;
registering the execution module as the agent when receiving an application including the execution module;
executing the execution module registered as the agent for two or more tasks included in the value chain, performing a simulation of executing the task, and measuring a KPI for a result of the simulation;
paying a reward corresponding to an execution result to the execution module executed in the simulation; and
receiving the reward.
